(19) United States
(12) Patent Application Publication
(10) Pub. No.: US 2018/0008846 A1
(43) Pub. Date: Jan. 11, 2018

(54) NASAL MASK

(71) Applicant: JUNG-CHEN CHANG, Taichung City (TW)

(72) Inventor: JUNG-CHEN CHANG, Taichung City (TW)

(21) Appl. No.: 15/204,256

(22) Filed: Jul. 7, 2016

(51) Int. Cl. A62B 9/04; A62B 18/02; A62B 18/08; A62B 23/02

(52) U.S. Cl. CPC A62B 9/04; A62B 23/025; A62B 18/025; A62B 18/084

(57) ABSTRACT

A nasal mask is provided, including: a cover body, at least a part thereof made of a material having air-penetrating and air-filtering characteristics, the cover body having first and second faces which are convex and concave, the nose being received in a space defined by the second face, a periphery of the cover body defining a datum face, the cover body having a nose tip portion, a top portion and two nose wing portions, the nose tip portion located between the two nose wing portions, the top portion and the two nose wing portions being near the periphery of the cover body; a framework, fixedly connected with and along the periphery of the cover body, the framework having shape-retention characteristic to retain the cover body in a specific shaped into which the cover body is shaped.

### BACKGROUND OF THE INVENTION

### Field of the Invention

The present invention relates to a filter device, and more particularly to a nasal mask.

### Description of the Prior Art

Conventionally, a nasal mask can filter air to prevent particulate matters in the air from being inhaled by people and endangering their health.

However, the conventional nasal mask uses more than one rope to arrange the nasal mask on a user's head or ears, and it may be uncomfortable and inconvenient for the user to use and does not have an appearing design. In addition, if the rope is snagged accidentally, the user may feel hurt.

The present invention has arisen to mitigate and/or obviate the afore-described disadvantages.

### SUMMARY OF THE INVENTION

The major object of the present invention is to provide a nasal mask, which can be fixed on a nose of a user without using ropes additionally.

To achieve the above and other objects, a nasal mask is provided, including: a cover body, at least a part thereof made of a material having air-penetrating and air-filtering characteristics, the cover body being three-dimensional and having a first face which is convex and a second face which is concave, the second face for being attached around a nose of a user, the nose being received in a space defined by the second face, a periphery of the cover body defining a datum face, the cover body having a nose tip portion, a top portion and two nose wing portions, the nose tip portion located on a position of the cover body where is farthest from the datum face and located between the two nose wing portions, the top portion and the two nose wing portions being near the periphery of the cover body, when the cover body covers the nose of the user, the top portion corresponds to an upper end of the nose, the nose tip portion corresponds to a nose tip of the nose, and the two nose wing portions respectively correspond to two nose wings of the nose; a framework, fixedly connected with and along the periphery of the cover body, the framework having shape-retention characteristic to retain the cover body in a specific shaped into which the cover body is shaped.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a partially-enlarged cross-sectional view of the preferred embodiment of the present invention;

FIG. 3 is a breakdown view of the preferred embodiment of the present invention;

FIG. 4 is a cross-sectional side view of the preferred embodiment of the present invention;

FIGS. 5 and 6 are drawings showing the preferred embodiment of the present invention in use;

FIG. 7 is a stereogram of another preferred embodiment of the present invention; and

FIG. 8 is a breakdown view of another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

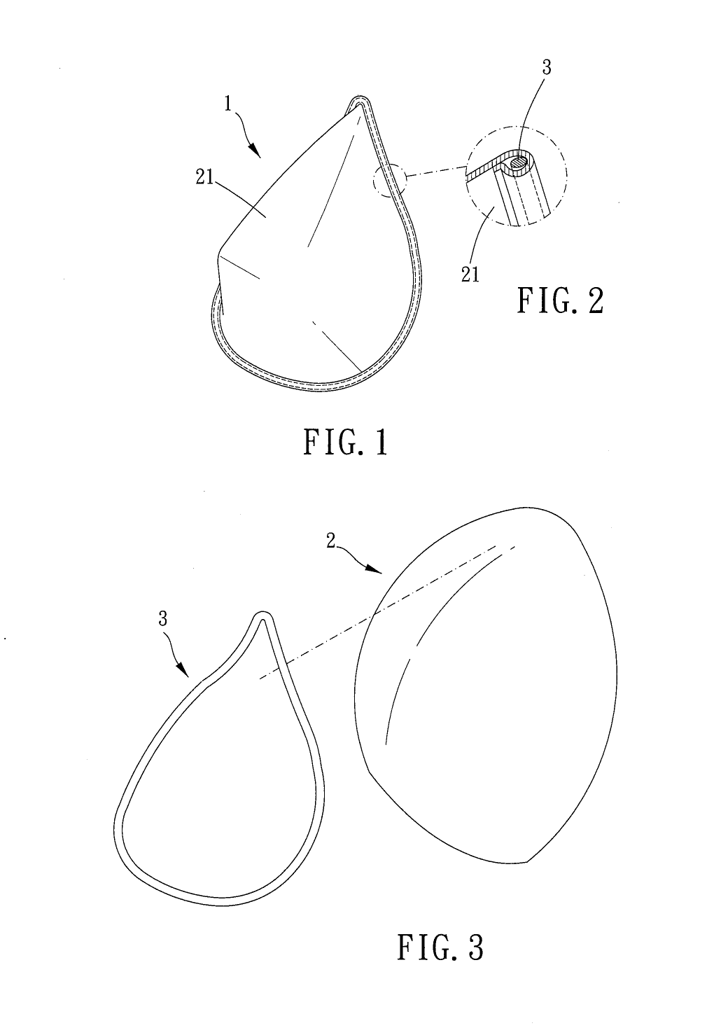

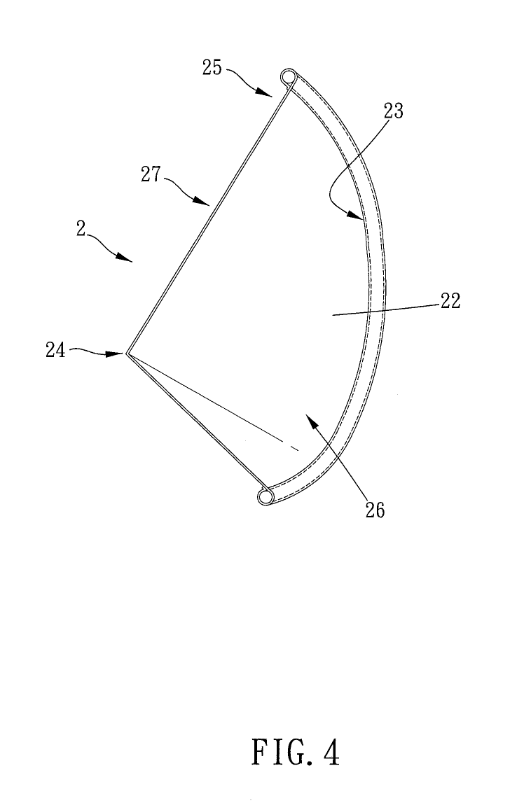

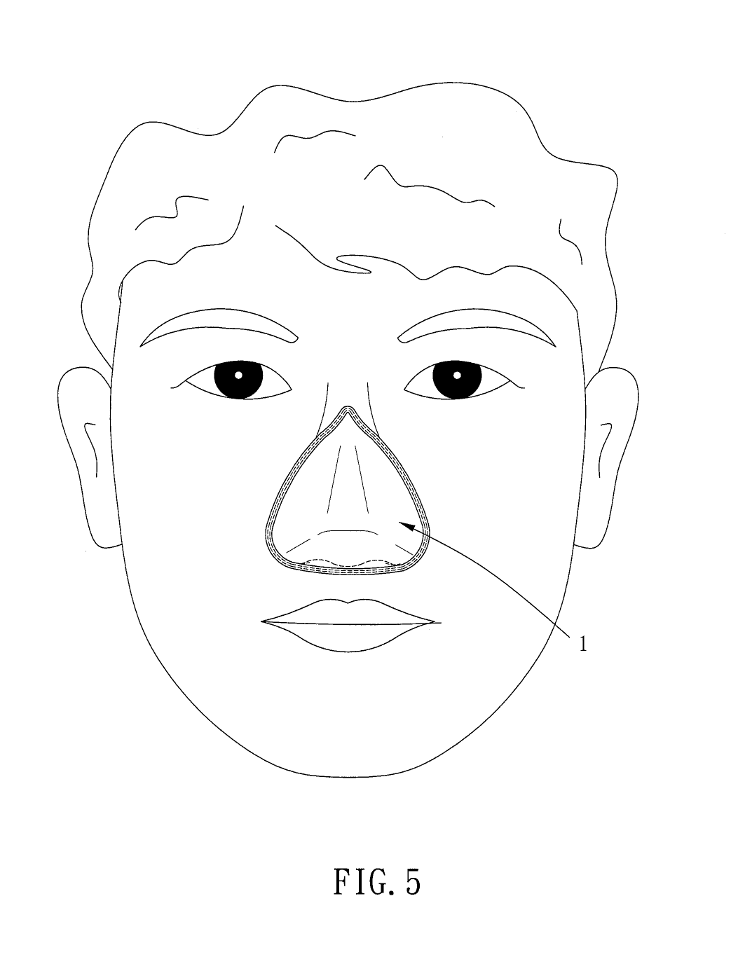

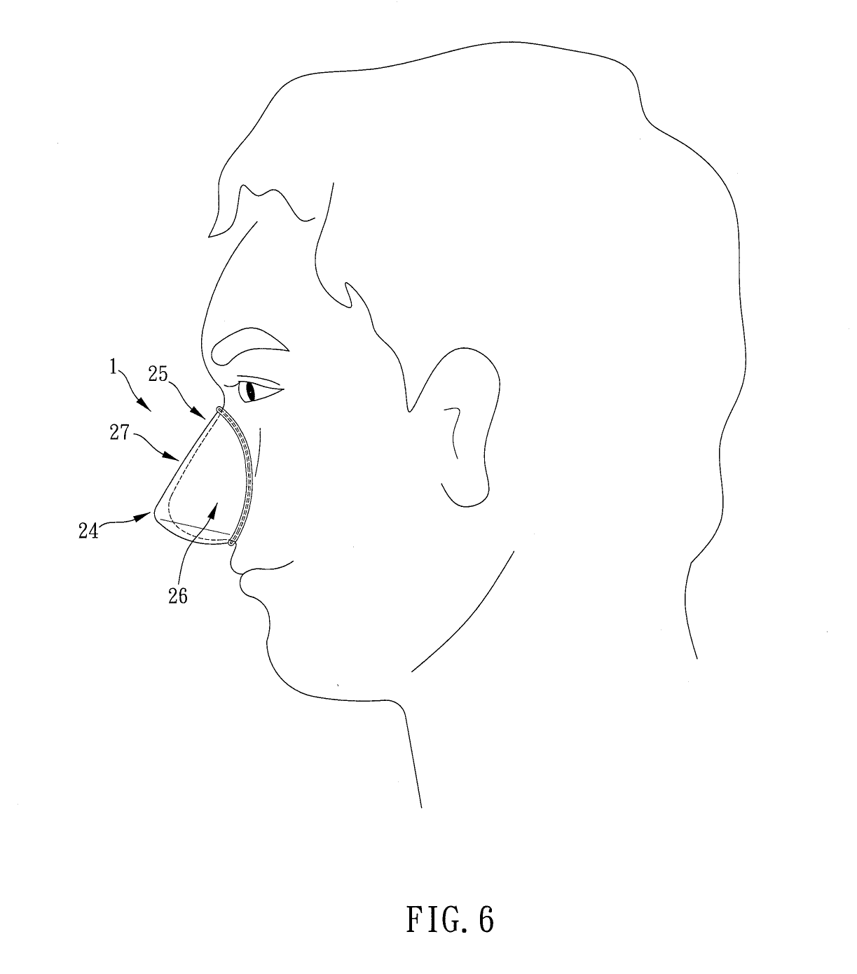

Please refer to FIGS. 1 to 6 for a preferred embodiment of the present invention. A nasal mask 1 includes a cover body 2 and a framework 3.

The cover body 2 is made of a material having air-penetrating and air-filtering characteristics, the cover body 2 is three-dimensional and has a first face 21 which is convex and a second face 22 which is concave, the second face 22 is for being attached around a nose of a user, the nose is received in a space defined by the second face 22, a periphery of the cover body 2 defines a datum face 23, the cover body 2 has a nose tip portion 24, a top portion 25 and two nose wing portions 26, the nose tip portion 24 is located on a position of the cover body 2 where is farthest from the datum face 23 and located between the two nose wing portions 26, the top portion 25 and the two nose wing portions 26 are near the periphery of the cover body 2, and when the cover body 2 covers the nose of the user, the top portion 25 corresponds to an upper end of the nose, the nose tip portion 24 corresponds to a nose tip of the nose, and the two nose wing portions 26 respectively correspond to two nose wings of the nose. The framework 3 is fixedly connected with and along the periphery of the cover body 2, the framework 3 has shape-retention characteristic to retain the cover body 2 in a specific shaped into which the cover body 2 is shaped. Therefore, a part of the framework 3 which is located on the nose wing portion 26 can abut against a root portion of the nose wing of the user.

In this embodiment, the framework 3 is arranged on the first face 21 of the cover body 2 near the periphery of the cover body 2, and the periphery of the cover body 2 is rolled back outwardly to cover and wrap the framework 3 therein to prevent the framework 3 from contacting skin directly. The framework 3 is annular and surrounds the periphery of the cover body 2 for a circle to stabilize a structure of the nasal mask 1. The framework 3 is a layer made of PP or ABS materials, and it is understandable that the framework 3 may be made of other materials such as PVC or PLA, but not limited thereto. A nose bridge portion 27 is connected with and between the nose tip portion 24 and the top portion 25, and the nose bridge portion 27 can make the nasal mask 1 be more three-dimensional and closer to a nose bridge of the user.

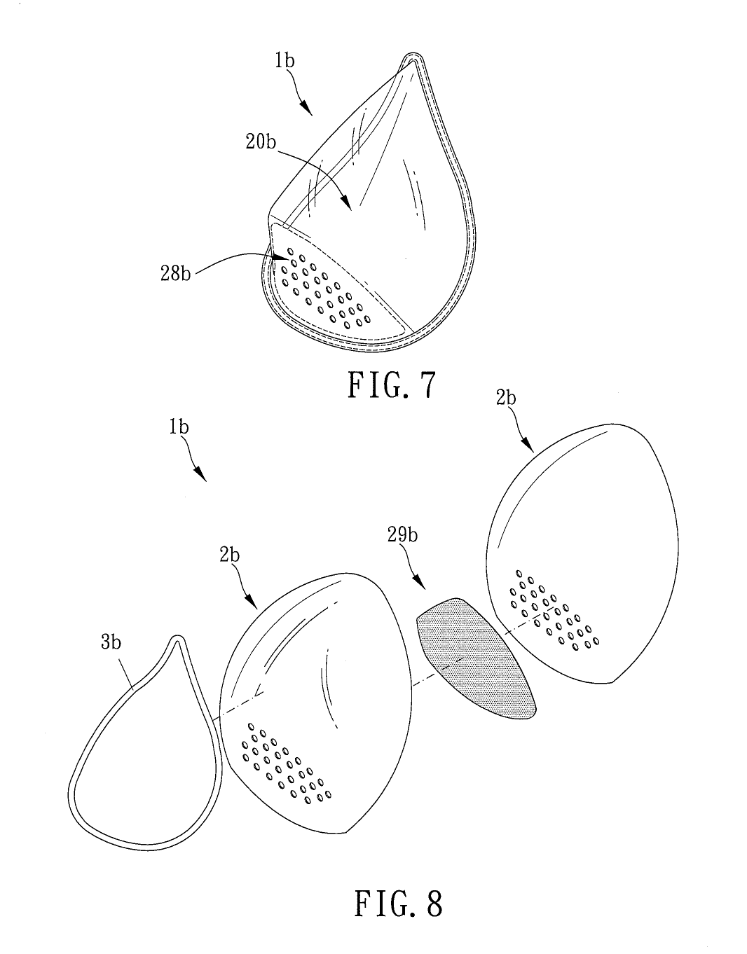

Please refer to FIGS. 7 and 8 for another embodiment, the cover body 2b includes a cover portion 20b and a ventilation portion 28b, and a part of the cover body 2b is holed therethrough and covered by a filter layer 29b to form the ventilation portion 28b. Specifically, the framework 3b is made of a transparent material, the filter layer 29b of the nasal mask is fixedly clamped by two transparent cover bodies, the filter layer 29b corresponds to nostrils of the user, and each said transparent cover body has through holes corresponding to the filter layer 29b (in other embodiments, the cover portion may be made of a non-transparent material in other colors, and the nasal mask may be provided with only one said cover body). Preferably, the filter layer 29b may be made of a material with a color similar to skin color, so it would not be obvious when the user wears the nasal mask 1b.

In other embodiments, the framework may be arranged on the second face of the cover body near the periphery of the cover body, and the periphery of the cover body is rolled back inwardly to cover and wrap the framework therein; the framework is arranged on the first face of the cover body near the periphery of the cover body and is fixed on the cover body through hot-pressing as long as the framework does not contact the user directly; the cover body of the nasal mask may be formed by a plurality of layers with a same or different filter function(s) or smell(s), and the framework of the nasal mask may be arranged in and wrapped by the layers as long as a side of the framework facing the second face is wrapped; the framework of the nose work may also include an metal wire for adjusting a shape of the framework in accordance with different requirements; and the cover body of the nasal mask may be attached with patterns or words on the first face to make the nasal mask unique.

In other embodiments, the framework may be non-annular and arranged along the periphery of the cover body, for example, a C-shaped framework (but not limited thereto) as long as the framework can abut against the root portion of the nose wing of the user; and the nasal mask may include a clamping structure disposed on the framework near the nose tip portion, the clamping structure can extend to clamp the nose bridge of the user so as to stably fix the nasal mask on the nose of the user.

Given the above, the nasal mask can filter air, and the framework of the nasal mask can be stably fixed on the nose of the user without using ropes additionally, and the nasal mask is easy, quick and convenient to be used.

While we have shown and described various embodiments in accordance with the present invention, it should be clear to those skilled in the art that further embodiments may be made without departing from the scope of the present invention.

What is claimed is:

1. A nasal mask, including:
a cover body, at least a part thereof made of a material having air-penetrating and air-filtering characteristics, the cover body being three-dimensional and having a first face which is convex and a second face which is concave, the second face for being attached around a nose of a user, the nose being received in a space defined by the second face, a periphery of the cover body defining a datum face, the cover body having a nose tip portion, a top portion and two nose wing portions, the nose tip portion located on a position of the cover body where is farthest from the datum face and located between the two nose wing portions, the top portion and the two nose wing portions being near the periphery of the cover body, when the cover body covers the nose of the user, the top portion corresponds to an upper end of the nose, the nose tip portion corresponds to a nose tip of the nose, and the two nose wing portions respectively correspond to two nose wings of the nose;
a framework, fixedly connected with and along the periphery of the cover body, the framework integrally formed and being flexible, the framework having shape-retention characteristic to retain the cover body in a specific shape into which the cover body is shaped.

2. The nasal mask of claim 1, wherein the framework is arranged on the first face of the cover body near the periphery of the cover body, and the periphery of the cover body is rolled back outwardly to cover and wrap the framework therein.

3. The nasal mask of claim 1, wherein the framework is arranged on the second face of the cover body near the periphery of the cover body, and the periphery of the cover body is rolled back inwardly to cover and wrap the framework therein.

4. The nasal mask of claim 1, wherein the framework is arranged on the first face of the cover body near the periphery of the cover body and is fixed on the cover body through hot-pressing.

5. The nasal mask of claim 1, wherein the framework is annular and surrounds the periphery of the cover body for a circle.

6. The nasal mask of claim 1, wherein the framework is a layer made of PP or ABS materials.

7. The nasal mask of claim 1, wherein the framework includes a metal wire.

8. The nasal mask of claim 1, wherein a nose bridge portion is connected with and between the nose tip portion and the top portion.

9. The nasal mask of claim 1, wherein the cover body includes a cover portion and a ventilation portion, and a part of the cover body is holed therethrough and covered by a filter layer to form the ventilation portion.

10. The nasal mask of claim 9, wherein the framework is made of a transparent material, the filter layer of the nasal mask is fixedly clamped by two transparent cover bodies, the filter layer corresponds to nostrils of the user, and each said transparent cover body has through holes corresponding to the filter layer.
